(19) United States
(12) Patent Application Publication
(10) Pub. No.: US 2009/0178297 A1
(43) Pub. Date: Jul. 16, 2009

(54) Heating and dehumiidifying system for compressed-air driven paint-drying guns

(75) Inventor: Mark E. Charpie, Ottawa Lake, MI (US)

Correspondence Address: Steven W. Weinrieb;LAW OFFICE OF STEVEN W. WEINRIEB, 8717 Cold Spring Road, Potomac, MD, 20854, US

(73) Assignee: ILLINOIS TOOL WORKS INC.

(21) Appl. No.: 12/007,525

(22) Filed: Jan. 11, 2008

(51) Int. Cl. F26B 3/18; F26B 21/00

(52) U.S. Cl. 34/443; 34/72; 34/80

(57) ABSTRACT

A drying system for waterborne materials, more particularly, water-borne basecoat paints, wherein the incoming compressed air, normally conducted through a plurality of dryer guns for use within the drying process, is heated at a position upstream or outside of the paint-drying booth so as to improve the drying time of, for example, the waterborne basecoat paints. In addition, the compressed air, as well as ambient air, is also conducted through desiccant dryers so as to further improve the drying time of the materials.

### FIELD OF THE INVENTION

The present invention relates generally to drying systems, and more particularly to a new and improved drying system for waterborne materials, more particularly, for water-borne basecoat paints, wherein the incoming compressed air, normally conducted through a plurality of dryer guns for use within the drying process, is heated at a position upstream or outside of the paint-drying booth so as to improve the drying time of, for example, the waterborne basecoat paints. In addition, since waterborne basecoat paints dry much slower in humid air than in dry air, the compressed air is conducted through a desiccant dryer located at a position upstream of the heater being used to heat the incoming compressed air. Still further, since the dryer guns actually exhaust a combination of compressed air and ambient air toward the painted surface to be dried, wherein, for example, the ambient air is entrained into the flow of the compressed air as the same flows through the dryer gun, a desiccant filter bed is effectively mounted onto the dryer gun at the location of the ambient air inlet port at which the ambient air normally enters the dryer gun.

### BACKGROUND OF THE INVENTION

The automotive refinishing industry is in the process of converting from solvent-based basecoat paints to waterborne basecoat paints in certain states, such as, for example, California, or in certain countries, such as, for example, Canada, in order to satisfy new government environmental regulations. For example, the use of the new waterborne basecoat paints will reduce the amount of volatile organic compounds that are released into the atmosphere. Conventionally, PRIOR ART drying systems, as disclosed for example within FIG. 1 and generally indicated by the reference character 100, comprises the use of one or more dryer guns 102 which are normally mounted upon one or more stands and which are used to blow compressed air, supplied from the facility's compressed air supply 104, onto the painted surfaces in order to accelerate the drying time. The dryer guns 102 are operatively and fluidically connected to a compressed air hose 106, which is operatively and fluidically connected to the compressed air supply 104, by means of a suitable quick-connect/disconnect mechanism 108, and a control valve 110 is also operatively associated with quick-connect/disconnect mechanism 108 so as to permit air to flow into the gun 102 or to terminate air flowing to the gun 102. In addition, as the compressed air flows through the compressed air hose 106, and through the dryer gun 102 so as to be effectively exhausted from a discharge port 112 located at the upper front end portion of the dryer gun 102 and therefore directed toward and onto the painted surface to be dried, ambient air is simultaneously entrained into the compressed air fluid flow path as a result of the dryer gun 102 being provided with an ambient air inlet port 114 which is located within the upper rear end portion of the dryer gun 102 wherein the ambient air inlet port 114 is substantially coaxial with the air discharge port 112. A suitable replaceable filter 116 is operatively associated with the ambient air inlet port 114 so as to prevent any airborne debris from passing through the dryer gun 102 and contaminating or marring the paint finish. The use of such new waterborne basecoat paints, however, has presented the automotive refinishing industry, such as, for example, collision repair facilities, with some productivity problems in that the new waterborne basecoat paints do not dry as quickly as the solvent-based basecoat paints, even when the aforenoted drying system 100 is employed.

A need therefore exists in the art for a new and improved drying system wherein the rate of drying of such waterborne basecoat paints can be significantly accelerated. Correspondingly, a need exists in the art for a new and improved drying system wherein the overall drying time of such waterborne basecoat paints can be significantly reduced.

### SUMMARY OF THE INVENTION

The foregoing and other objectives are achieved in accordance with the teachings and principles of the present invention through the provision of a new and improved drying system for waterborne materials, more particularly, waterborne basecoat paints, wherein the incoming compressed air, normally conducted through a plurality of dryer guns for use within the drying process, is heated at a position upstream or outside of the paint-drying booth so as to improve the drying time of, for example, the waterborne basecoat paints. In addition, since waterborne basecoat paints dry much slower in humid air than in dry air, the compressed air is conducted through a desiccant dryer located at a position upstream of the heater being used to heat the incoming compressed air. Still further, since the dryer guns actually exhaust a combination of compressed air and ambient air toward the painted surface to be dried, wherein, for example, the ambient air is entrained into the flow of the compressed air as the same flows through the dryer gun, a desiccant filter bed is effectively mounted onto the dryer gun at the location of the ambient air inlet port at which the ambient air normally enters the dryer gun.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic view of a conventional, PRIOR ART dryer gun drying system conventionally used in connection with the drying of refinished painted surfaces; and

FIG. 2 is a schematic view of a new and improved dryer gun drying system which has been constructed in accordance with the principles and teachings of the present invention and which illustrates the cooperative parts thereof.

### DETAILED DESCRIPTION OF THE PREFERRED EMBODIMENT

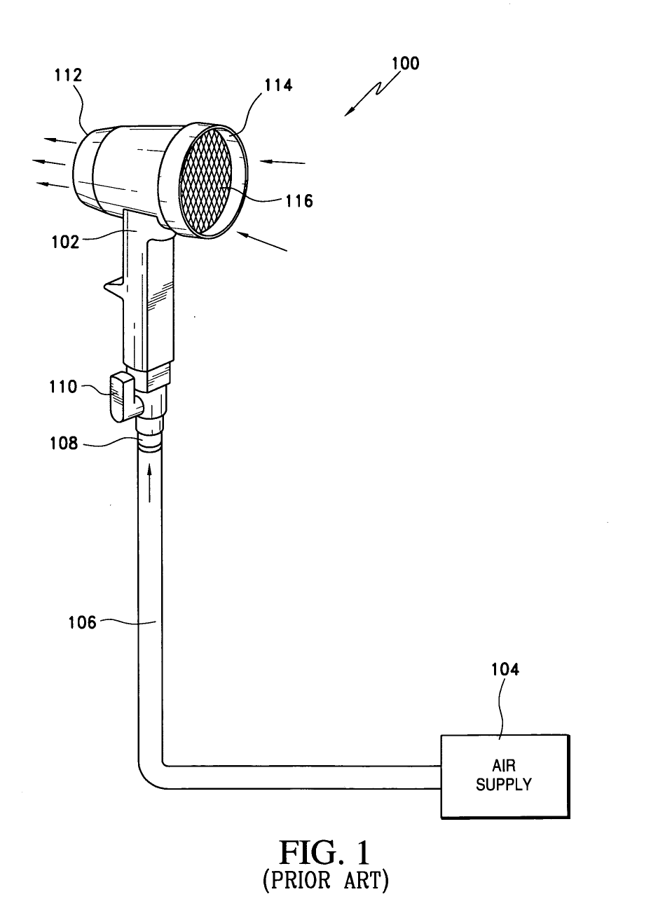

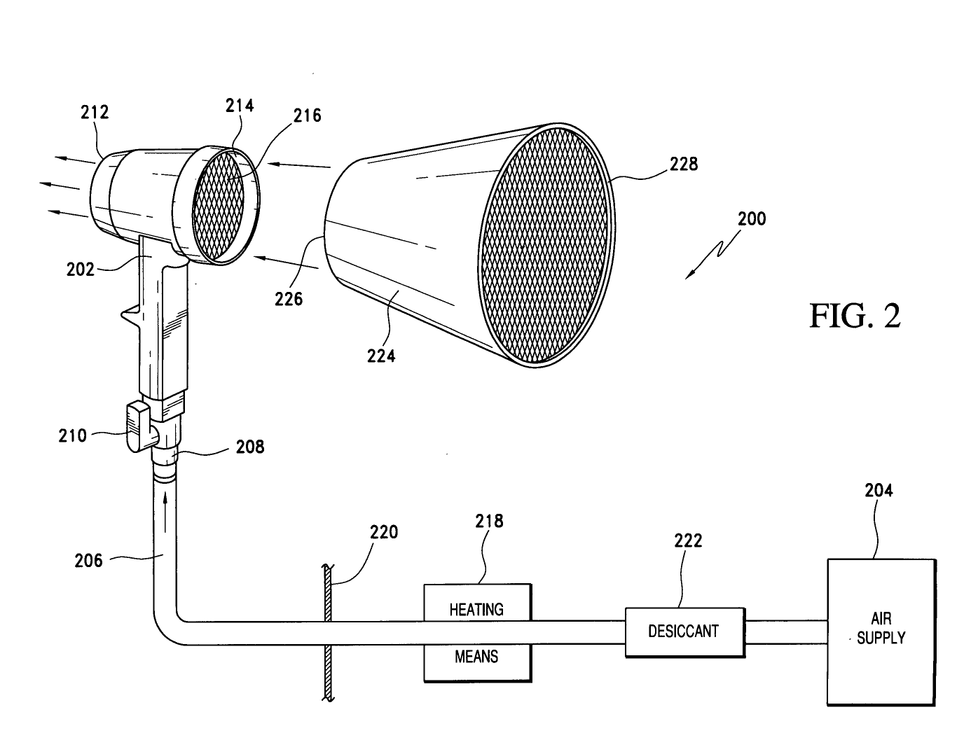

Referring now to the drawings, and more particularly to FIG. 2 thereof, a new and improved dryer gun drying system, which has been constructed in accordance with the principles and teachings of the present invention and which illustrates the cooperative parts thereof, is disclosed and is generally indicated by the reference character 200. It is to be noted that some of the component parts of the new and improved dryer gun drying system 200 of the present invention, and as disclosed within FIG. 2, are similar to the component parts of the conventional, PRIOR ART dryer gun drying system 100 as disclosed within FIG. 1, and accordingly, a detailed description of those component parts will be omitted herefrom for brevity purposes. In addition, those component parts of the new and improved dryer gun drying system 200 of the present invention as disclosed within FIG. 2, which correspond to the component parts of the conventional, PRIOR ART dryer gun drying system 100 as disclosed within FIG. 1, will be designated by corresponding reference numbers except that they will be within the 200 series. More particularly, it is seen that, in accordance with the principles and teachings of the present invention, in order to significantly accelerate the rate of drying of waterborne materials, such as, for example, waterborne basecoat paints, and to correspondingly significantly reduce the overall drying time of such waterborne materials, heating means 218, disposed externally or outside of the paint booth, schematically illustrated at 220, is operatively associated with the compressed air line or hose 206 leading to the dryer gun 202 such that the incoming compressed air is heated prior to being conducted through the dryer gun 202 and exhausted out from the discharge port 212. The air being exhausted out from the discharge port 212 therefore has an elevated temperature level, as compared to normal or regular compressed air conventionally supplied to the dryer guns, as illustrated within the PRIOR ART system of FIG. 1, and accordingly, the use of such heated air will effectively accelerate the rate of drying of such waterborne basecoat paints whereby, in turn, the drying time of, for example, the waterborne basecoat paints, will be significantly reduced.

In addition, since it is also known that waterborne basecoat paints dry much slower in relatively humid air than in relatively dry air, the compressed air from the air supply 204 is also conducted through a desiccant dryer 222 located at a position upstream of the heating means 218 being used to heat the compressed air being supplied to the dryer gun 202 from the compressed air supply 204 so as to effectively dehumidify or dry the compressed air being supplied to the dryer gun 202 from the compressed air supply 204. Still further, since the dryer gun 202 actually exhausts a combination of compressed air and ambient air toward the painted surface to be dried, wherein, for example, the ambient air is entrained into the flow of the compressed air as the same flows through the dryer gun 202, in accordance with further principles and teachings of the present invention, it is desirable to provide the dryer gun with a desiccant filter bed or container 224 for likewise dehumidifying or drying the entrained ambient air before the same enters the dryer gun 202. Accordingly, the desiccant filter bed or container 224 is effectively mounted onto the dryer gun 202 at the ambient air inlet port 214 of the dryer gun 202. The desiccant filter bed or container 224 has a substantially frusto-conically shaped configuration such that the smaller, forward or downstream end portion 226 of the desiccant filter bed or container 224 can be, for example, snap-fitted onto the ambient air inlet port 214 of the dryer gun 202, threadedly mounted upon the ambient air inlet port 214 of the dryer gun 202, or the like. Conversely, the larger, rearward or upstream end portion of the desiccant filter bed or container 224 is provided with an enlarged ambient air inlet port 228 so as to not adversely affect the pressure drop and fluid flow of the ambient air into and through the desiccant filter bed or container 224. For example, while the conventional ambient air inlet port 214 may have a diametrical extent on the order of, for example, two inches (2.00″), the enlarged ambient air inlet port 228 of the desiccant filter bed or container 224 has a diametrical extent on the order of, for example, one foot or twelve inches (12.00″). It is to be noted that as a result of using heated compressed air, along with the desiccant beds 222,224, faster drying times of the waterborne basecoat paints are able to achieved than is conventionally achieved with solvent based basecoat paints.

Thus, it may be seen that in accordance with the principles and teachings of the present invention, there has been disclosed a new and improved drying system for waterborne materials, more particularly, waterborne basecoat paints, wherein the incoming compressed air, normally conducted through a plurality of dryer guns for use within the drying process, is heated at a position upstream or outside of the paint-drying booth so as to improve the drying time of, for example, the waterborne basecoat paints. In addition, since waterborne basecoat paints dry much slower in humid air than in dry air, the compressed air is conducted through a desiccant dryer located at a position upstream of the heater being used to heat the incoming compressed air. Still further, since the dryer guns actually exhaust a combination of compressed air and ambient air toward the painted surface to be dried, wherein, for example, the ambient air is entrained into the flow of the compressed air as the same flows through the dryer gun, a desiccant filter bed is effectively mounted onto the dryer gun at the location of the ambient air inlet port at which the ambient air normally enters the dryer gun.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A system for drying materials, comprising:
a dryer gun for drying materials to be dried;
an air discharge port defined upon said dryer gun for discharging air onto said materials to be dried so as to dry said materials to be dried;
a supply of compressed air;
conduit means for conducting said compressed air from said supply of compressed air and into said dryer gun such that said compressed air can be discharged from said discharge port of said dryer gun and onto said materials to be dried; and
means, operatively associated with said conduit means at a position upstream of said dryer gun, for heating said compressed air prior to said compressed air being conducted into said dryer gun such that said dryer gun exhausts heated compressed air onto said materials to be dried so as to accelerate the rate of drying of said materials to be dried and thereby reduce the time required to dry said materials to be dried.

2. The system as set forth in claim 1, wherein:
said materials to be dried comprise waterborne based materials.

3. The system as set forth in claim 2, wherein:
said waterborne based materials comprise waterborne based basecoats of paint.

4. The system as set forth in claim 1, further comprising:
first desiccant means, operatively associated with said conduit means at a position upstream of said dryer gun, for dehumidifying said compressed air prior to said compressed air being conducted into said dryer gun such that said dryer gun exhausts dehumidified heated compressed air onto said materials to be dried so as to accelerate the rate of drying of said materials to be dried and thereby reduce the time required to dry said materials to be dried.

5. The system as set forth in claim 4, wherein:
said first desiccant means is disposed upstream of said means for heating said compressed air.

6. The system as set forth in claim 4, further comprising:
an ambient air inlet port defined upon said dryer gun, and fluidically connected to said discharge port of said dryer gun, for permitting ambient air to enter said dryer gun and to be entrained with said heated compressed air being discharged from said discharge port of said dryer gun such that both said heated compressed air and said ambient air will be discharged onto said materials to be dried.

7. The system as set forth in claim 6, further comprising:
second desiccant means, operatively connected to said ambient air inlet port of said dryer gun, for dehumidifying said ambient air prior to said ambient air entering said ambient air inlet port of said dryer gun and being entrained with said heated compressed air such that said dryer gun exhausts dehumidified heated compressed air and dehumidified ambient air onto said materials to be dried so as to accelerate the rate of drying of said materials to be dried and thereby reduce the time required to dry said materials to be dried.

8. The system as set forth in claim 7, further comprising:
means for removably mounting said second desiccant means upon said ambient air inlet port of said dryer gun.

9. A system for drying materials, comprising:
a dryer gun for drying materials to be dried;
an air discharge port defined upon said dryer gun for discharging air onto said materials to be dried so as to dry said materials to be dried;
a supply of compressed air;
conduit means for conducting said compressed air from said supply of compressed air and into said dryer gun such that said compressed air can be discharged from said discharge port of said dryer gun and onto said materials to be dried;
an ambient air inlet port defined upon said dryer gun, and fluidically connected to said discharge port of said dryer gun, for permitting ambient air to enter said dryer gun and to be entrained with said compressed air being discharged from said discharge port of said dryer gun such that both said compressed air and said ambient air will be discharged onto said materials to be dried; and
desiccant means, operatively connected to said ambient air inlet port of said dryer gun, for dehumidifying said ambient air prior to said ambient air entering said ambient air inlet port of said dryer gun and being entrained with said compressed air such that said dryer gun exhausts compressed air and dehumidified ambient air onto said materials to be dried so as to accelerate the rate of drying of said materials to be dried and thereby reduce the time required to dry said materials to be dried.

10. The system as set forth in claim 9, further comprising:
means for removably mounting said desiccant means upon said ambient air inlet port of said dryer gun.

11. The system as set forth in claim 9, further comprising:
second desiccant means, operatively associated with said conduit means at a position upstream of said dryer gun, for dehumidifying said compressed air prior to said compressed air being conducted into said dryer gun such that said dryer gun exhausts dehumidified compressed air and dehumidified ambient air onto said materials to be dried so as to accelerate the rate of drying of said materials to be dried and thereby reduce the time required to dry said materials to be dried.

12. The system as set forth in claim 9, wherein:
said materials to be dried comprise waterborne based materials.

13. The system as set forth in claim 12, wherein:
said waterborne based materials comprise waterborne based basecoats of paint.

14. A method for drying materials, comprising the steps of:
using a dryer gun for drying materials to be dried;
providing an air discharge port upon said dryer gun for discharging air onto said materials to be dried so as to dry said materials to be dried;
providing a supply of compressed air;
conducting said compressed air through a conduit from said supply of compressed air and into said dryer gun such that said compressed air can be discharged from said discharge port of said dryer gun and onto said materials to be dried; and
heating said compressed air, flowing through said conduit, at a position upstream of said dryer gun, such that said compressed air is heated prior to said compressed air being conducted into said dryer gun whereby said dryer gun will exhaust heated compressed air onto said materials to be dried so as to accelerate the rate of drying of said materials to be dried and thereby reduce the time required to dry said materials to be dried.

15. The method as set forth in claim 14, wherein:
said materials to be dried comprise waterborne based materials.

16. The method as set forth in claim 15, wherein:
said waterborne based materials comprise waterborne based basecoats of paint.

17. The method as set forth in claim 14, further comprising the step of:
operatively associating first desiccant means with said conduit, at a position upstream of said dryer gun, for dehumidifying said compressed air prior to said compressed air being conducted into said dryer gun such that said dryer gun exhausts dehumidified heated compressed air onto said materials to be dried so as to accelerate the rate of drying of said materials to be dried and thereby reduce the time required to dry said materials to be dried.

18. The method as set forth in claim 17, further comprising the step of:
using said first desiccant means to dehumidify said compressed air prior to said heating of said compressed air.

19. The method as set forth in claim 17, further comprising the step of:
providing an ambient air inlet port upon said dryer gun, such that said ambient air inlet port is fluidically connected to said discharge port of said dryer gun, so as to permit ambient air to enter said dryer gun and to be entrained with said heated compressed air being discharged from said discharge port of said dryer gun such that both said heated compressed air and said ambient air will be discharged onto said materials to be dried.

20. The method as set forth in claim 19, further comprising the step of:
using second desiccant means, operatively connected to said ambient air inlet port of said dryer gun, for dehumidifying said ambient air prior to said ambient air entering said ambient air inlet port of said dryer gun and being entrained with said heated compressed air such that said dryer gun exhausts dehumidified heated compressed air and dehumidified ambient air onto said materials to be dried so as to accelerate the rate of drying of said materials to be dried and thereby reduce the time required to dry said materials to be dried.
